(19) United States
(12) Patent Application Publication
(10) Pub. No.: US 2007/0213216 A1
(43) Pub. Date: Sep. 13, 2007

(54) Surface Decorated Wind Ornament

(76) Inventors: Peter F. Lindemann, Aurora, CO (US); Angela D. Bowen, Aurora, CO (US); Joshua J. Jones, Lakewood, CO (US)

Correspondence Address: KYLE W. ROST, 5490 AUTUMN CT., GREENWOOD VILLAGE, CO, 80111, US

(21) Appl. No.: 11/307,190

(22) Filed: Jan. 26, 2006

(51) Int. Cl. B41M 5/50

(52) U.S. Cl. 503/227

(57) ABSTRACT

A shiny metal base ornament is configured with a series of concentric geometric figures of sequentially decreasing sizes from periphery toward center, with a slot separating juxtaposed geometric figures, and a spine joins juxtaposed geometric figures across the slot. A surface coating is of clear substrate suited to receive dye sublimation inks. The coating carries a graded surface color scheme of dye sublimation inks. A method of forming employs a computerized physical design and an extracted cutout image that provides a template for a coloration pattern that registers precisely with the physical ornament. Color gradations cross slots to coat cut edges during sublimation.

### BACKGROUND OF THE INVENTION:

1. Field of the Invention

The invention generally relates to a decorated article constructed of stock material and constituting a special occasion ornament in the nature of a wind ornament. More specifically, the invention relates to treated surfaces of a decorative article, especially an article constructed from flat sheet material and decorated with an ink impregnated clear coat over shiny metal.

2. Description of Related Art Including Information Disclosed Under 37 CFR 1.97 and 1.98

A variety of ornamental articles are designed to interact with moving air and light to create changing visual effects. These articles, which could be called wind ornaments, are called by different names, depending upon the preferences of the creator or producer. One suitable name is kinetic sculpture, which has been applied to a hanging spiral ornament in U.S. Pat. Des. 413,078. Another suitable name is suncatcher, which has been applied to a hanging array of dished tendrils in U.S. Pat. Des. 479,482. Still another such article is simply called an ornamental device in U.S. Pat. No. 6,783,815.

All of these devices and others can be suspended from a cord and placed in an outdoor area where sunlight and wind are present to interact with the devices and create changing visual effects. The visual effects arise, in part, from movement such as twirling movement on the cord. The visual effects also arise from changing reflection of light and changing shadows. The devices also may have one or more colored surface finishes that add another source of variation in appearance. A popular added surface finish is a colored varnish.

It would be desirable to expand the types of visual effects on a wind ornament. It is especially desirable to take advantage of sunlight due to the quality of its brightness and available spectrum to increase the range of dynamic variations in the light reflected from a wind ornament.

One type of desirable surface treatment or surface finish is applied by dye sublimation inks. This general type of finish has been employed for many years on fabrics, as an alternative to silk screening. Improvements in technology are allowing the use of dye sublimation inks on other flat surfaces and, in some cases, on three-dimensional surfaces. U.S. Pat. No. 5,962,368 to Poole demonstrates the recent advance in decorating a three-dimensional object by encasing it in heat shrink film that is shrunk by heat to press the sublimation inks against the object to allow proper transfer of the design. The art teaches that this technique can be effective on metal objects covered by a white base coat, which then may be covered by a substrate that can be either transparent or clear-tinted topcoat. The dyes are transparent, which has led workers in this art to follow conventional teaching that the base coating should be light in color, such as white, light gray, or beige.

In order to dye a three-dimensional work piece, first the dyes are applied to a support or transfer sheet, often by a printing process that may include ink-jet printing. Often this is done under control of a general-purpose computer operating suitable software. The ink-jet printer may be a commercially available dye sublimation printer. The inked transfer sheet is pressed against a substrate on the workpiece, and heat is applied. The heat causes the dyes to vaporize. If they are in close proximity to a suitable substrate, such as a plastic top coating on the workpiece, the vapors penetrate the adjacent substrate by around 0.002 in. up to 0.25 in. Typically, the plastic substrate must be able to withstand temperatures of 280° to 375° F, which are necessary to vaporize the dye.

The surface-decorated wind ornament is formed of a shiny metal base ornament configured with a series of concentric geometric figures of sequentially decreasing sizes from a periphery toward a center, with a slot separating juxtaposed geometric figures. A spine joins juxtaposed geometric figures across the slot. The metal base ornament carries a surface coating of clear substrate suited to receive dye sublimation inks. The substrate carries a graded surface color scheme of dye sublimation inks.

To achieve the foregoing and other objects and in accordance with the purpose of the present invention, as embodied and broadly described herein, the method and apparatus of this invention may comprise the following.

### BRIEF SUMMARY OF THE INVENTION

Against the described background, it is therefore a general object of the invention to provide a method of producing a wind ornament with novel surface decoration having inner reflective properties.

It would be desirable to adapt dye sublimation printing techniques to the decoration of wind ornaments. Further, it would be desirable to create new and modified techniques for the design, production, and declaration of wind ornaments, in order to create an enhanced range of visual effects in the finished product.

According to the method, a planar physical configuration for the wind ornament is designed to include a series of concentric geometric figures of sequentially decreasing sizes from periphery toward center. A slot separates juxtaposed geometric figures. A spine joins juxtaposed geometric figures across the slot. The wind ornament is formed from a metal sheet according to the designed physical configuration. The formed wind ornament is coated with a substrate suited to receive dye sublimation inks. Then the coated wind ornament is colored with dye sublimation inks.

The selected metal sheet is shiny or shined to provide a reflecting backing for a clear-coat of polyester substrate.

A pattern for coloring the wind ornament is designed by first obtaining a cutout image of the physical configuration design for the wind ornament. Then a color scheme is designed using the cutout image as a template. In the color scheme, color is graded across the series of concentric geometric figures. An image of the color scheme is printed on a transfer sheet in dye sublimation inks. The printed image is registered with the coated wind ornament, and then heat and pressure are applied to the registered image and ornament to transfer the image in sublimation inks to the substrate coating.

Grading color across the geometric figures can be done by grading color between different colors; grading color between different densities of one color; grading color by contour of each concentric geometric figure; and grading color continuously across positions of the slots separating juxtaposed geometric figures.

The accompanying drawings, which are incorporated in and form a part of the specification, illustrate preferred embodiments of the present invention, and together with the description, serve to explain the principles of the invention. In the drawings:

### BRIEF DESCRIPTION OF THE SEVERAL VIEWS OF THE DRAWINGS

FIG. 1 is a schematic flow diagram of the process by which a wind ornament is designed and produced as a product having a configuration appropriate to register with a pattern of dye sublimation inks on a transfer sheet.

FIG. 2 is a schematic flow diagram of the process by which a suitable transfer sheet is produced to carry dye sublimation inks in a pattern appropriate to register with a clear-coated product.

FIG. 3 is a schematic flow diagram of the process by which a clear-coated product is registered with a coordinated pattern of dye sublimation inks on a transfer sheet.

FIG. 4 is a front elevational view of a wind ornament produced in accordance with the methods of FIGS. 1-3, and showing an added hanging cord.

FIG. 5 is a front elevational view of a transfer sheet bearing a representative pattern of dye sublimation ink for application to a clear-coated product to create the wind ornament of FIG. 4.

FIG. 6 is a schematic detail view in transverse cross-section, showing an assembly of a pair of transfer sheets carrying dye sublimation ink, bounding the top and bottom faces of a clear-coated wind ornament, ready for placement in a heat press.

### DETAILED DESCRIPTION OF THE INVENTION

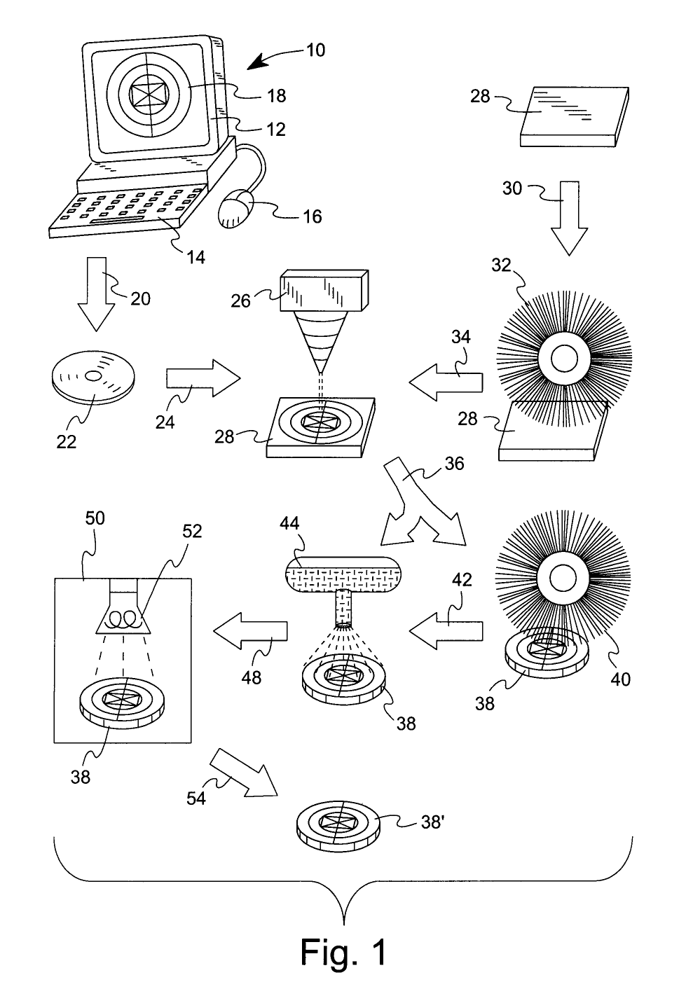

In a first contraction, the invention is a method for producing a uniquely decorated wind ornament. A closely related contraction of the invention is an article known as a wind ornament bearing a unique surface decoration. With reference to FIGS. 1-3 of the drawings, the method of producing a wind ornament according to the invention is coordinated with a method of producing a transfer sheet carrying a desired pattern of dye sublimation ink for transferring the pattern to the wind ornament. This coordinated method provides for the efficient and effective design and production of wind ornaments capable of producing unique and previously unachieved visual effects.

According to the method of producing a configured wind ornament without applied finish, a first step is to design the desired wind ornament. Starting at a first processing step at the upper left of FIG. 1, this design step is best accomplished on a general-purpose computer 10, which includes a microprocessor for executing software program instructions. The computer runs a software program suitable for designing a desired product and producing via an associated printer a full size color image of the product. The desired product is a wind ornament formed from sheet material. The wind ornament has various slots, gaps, and edges where the sheet material is cut away.

The color image is a full size image that extends colored areas over selected slots, gaps, and edges. At other selected areas, the color image is exact and creates clean boundaries between colors. The software program also is capable of communicating its design for transmission, printing, or storage. A currently available and suitable graphics software program is sold under the name, CoralDraw, a trademark of Corel Corporation, whose North American address is 1600 Carling Avenue, Ottawa, Ontario, Canada K1Z 8R7. This software program can be supplemented with extensive files of public domain clipart, which can serve as a ready source for center silhouettes or other ornamental figures suited for use as a center element of a wind ornament.

The general-purpose computer may include a graphic display device 12 such as a color monitor showing the design of the wind ornament under construction. A keyboard 14 and computer mouse 16 provide a means at the design station for selectively entering instructions for drawing the wind ornament. The configuration or drawing, or data signifying the drawing 18 as displayed on monitor 12 in FIG. 1 is schematic in nature for conveniently representing the wind ornament throughout FIGS. 1-3. Thus, throughout FIGS. 1-3, the illustrated image 18 will serve merely as an approximate representation of a electronically displayed design configuration for a wind ornament. A portion of the image, which will be referred to as the cutout image, will become the template for creating a computer drawing of color finish that will be applied to the wind ornament.

The design step creates the definition of the physical design or shape of the wind ornament, including suitable cut edges at the outer periphery of the wind ornament and at various slots and gaps within the cut edges. This definition serves as an aid in forming the product from blank stock. The design step then creates color image of the wind ornament by extracting a cutout image, using the designed cut edges of the outer periphery of the physical design. This cutout image is colored, in order to create a substantially perfectly matched color image that will register with the physical shape of the wind ornament. The shared date of the design between the color and shape images helps to provide a close correlation between the eventual color scheme expressed in areas of dye sublimation inks and the product shape. This correlation allows a registry or alignment between each designed product shape and it's associated inked pattern during the process of decorating the product.

The physical design 18 for a wind ornament is transmitted to an automated device for forming the physical wind ornament. The design produced at computer 10 can be recorded on a portable memory device. Thus, following arrow 20 to a transmission step or station, the computer 10 has created a recorded media device 22 that contains the drawing 18 or suitable electronic instructions for recreating it. Such a device 22 may be a compact disc or a floppy disk that physically carries the representation of drawing 18 in software. Alternatively, device 22 may represent the electronic transmission of the drawing 18, such as over a network, telephone lines or the Internet.

Arrow 24 shows that the software-generated drawing data 18 is received at a software-guided device for performing a cutting step or other forming step. A cutting machine 26 is capable of receiving the drawing data 18 and using the drawing data to aid in cutting or otherwise manufacturing the object in conformity with the drawn shape.

A second branch of the processing illustration begins at the upper right of FIG. 1. A wind ornament can be formed of a metal. A suitable example is mild steel. The right branch of the method begins with a step of selecting or supplying a sheet 28 of mild steel or other suitable metal material. At arrow 30, in an optional or alternative step, the sheet of metal is sent to a device for cleaning or shining the metal sheet 28. A suitable cleaning is by a chemical wash, physical abrasion, surface shining, or buffing. A representative brush 32 indicates any suitable device or method that cleans or shines the metal sheet.

The first and second processing branches merge at the forming step. At arrow 34, the second branch sends the metal sheet to the cutting machine 26 for processing to produce a base wind ornament 38. At arrow 24, the first branch has sent the design 18 to the cutting machine 26. Aided by software 22 to establish the design 18, cutting machine 26 cuts the pattern of the wind ornament from the metal sheet 28. A suitable cutting machine 26 is either a laser-cutting machine or a hydro-cutting machine. Other types of cutting or forming machines might be used.

From the cutting or forming step, forked arrow 36 leads to the next step where two options are available. The right-hand branch of arrow 36 directs processing of the cutout, base ornament 38 to an optional or alternative shining step. A suitable device or method, similar to those previously described cleans the base ornament 38, as may be required. A surface blasting device, brush or buffing wheel 40 may deburr the ornament 38, if necessary.

With completion of the optional shining step, processing of the base wind ornament 38 advances according to arrow 42 to a coating step. Alternatively, the left-hand branch of arrow 36 directs the cut wind ornament 38 directly from the cutting step to a coating step for applying a clear coat to the shiny metal. Typically the metal sheet 28 or the cut ornament 38 will require processing to clean or shine it at one of the alternative processing steps.

At a coating station, an applicator 44 coats the wind ornament 38 with a suitable clear substrate suitable for receiving sublimed ink. A preferred substrate coat is clear polyester powder and should be either pure polyester or have high polyester content. The clear polyester powder is applied to the shiny metal of the wind ornament 38 without a basecoat of typical white, light gray, or beige. Thus, the shiny metal shows through the clear polyester substrate. Applicator 44 might apply the polyester powder coating by a tribo-charging method or by an electrostatic method. The powder coating of polyester should be applied to all surfaces of the wind ornament 38.

At completion of the powder-coating step, processing of the coated wind ornament 38 follows arrow 48 to a curing step. Suitable methods of curing may include residence in or passage through a curing oven 50. An energy or radiation-emitting device 52 applies curing energy to the coating of powder coated wind ornament 38, for producing an initial product 38′ that will be coated with a substrate ready to receive coloration. Curing energy might be heat or selected portions of the light spectrum, such as infrared or ultraviolet light. Powder coating and curing is a preferred method for treating the surface of the wind ornament. Alternative methods of applying surface treatment might employ an agent that is carried in a solvent, such that curing may be unnecessary or may be replaced with a solvent removal step. Therefore, the step of applying a coating may be interpreted to include any curing that is necessary or desired, according to the technology practiced.

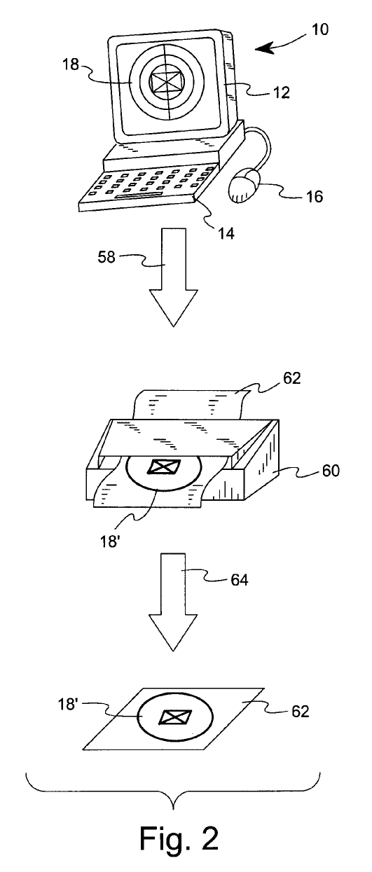

At the conclusion of the coating or curing step, processing advances according to arrow 54, which shows delivery of the wind ornament 38′ that is clear-coated with a substrate coating for receiving a decorative coating. The clear-coated wind ornament 38′ can be directed to a further processing step for application of novel decoration. FIG. 2 shows additional processing steps and stations.

FIG. 2 shows another portion of the method that starts with the previously described first step, wherein a general-purpose computer 10 performs the designing step. In this process, the design 18 will be rendered as colored areas of ink on an ink sublimation transfer sheet.

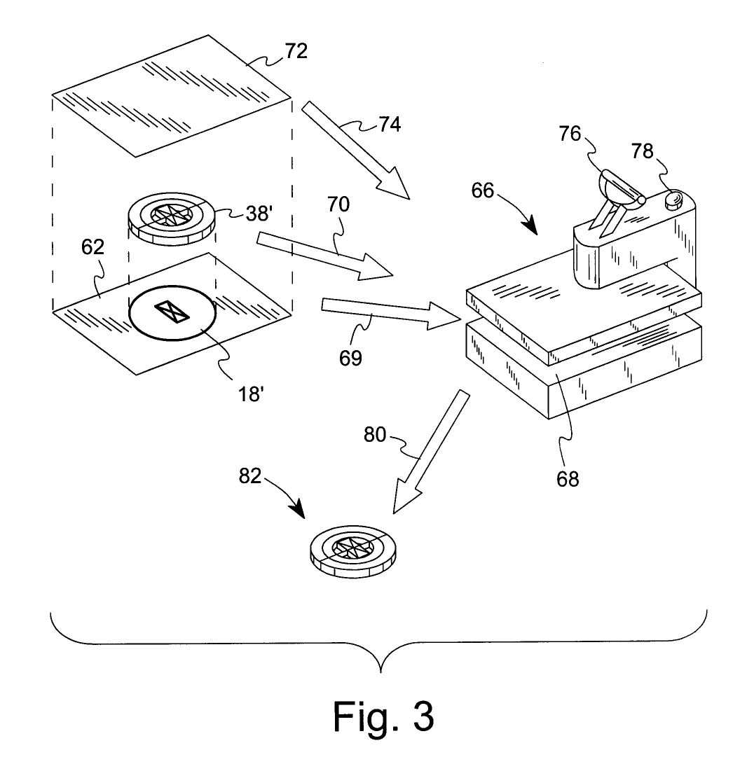

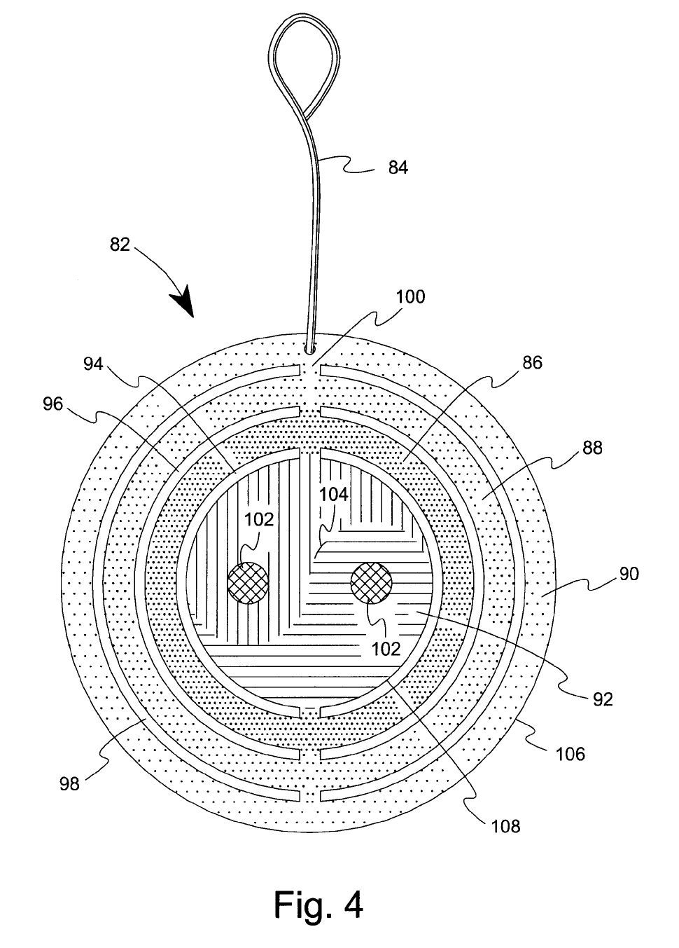

Notably, the data representing design 18 for purposes of printing is significantly less detailed than the data used for cutting. Selected areas of ink will extend beyond peripheral edges of slots and gaps of the physical design. Notably, some of the cutout areas, such as slots and gaps, are not specific limitations in the color areas of the design. Therefore, it may be noted that the printed design 18′ in FIGS. 2 and 3 appears to be simplified, and certain rings or markings suggestive of cuts, slots, and gaps are absent. These differences will be described in connection with FIGS. 4-6.

At arrow 58, the method advances to a printing step performed by a dye sublimation printer 60 that prints outputs in dye sublimation inks. The typical transmission between the computer 10 and the printer 60 is via a printer cable. Many brands of dye sublimation printer are commercially produced and are suitable. An Epson brand Stylus 1280 printer is an example of a suitable choice. This printer receives design data 18′ and prints the design 18′ on a sheet of transfer paper 62 suitable for receiving dye sublimation inks. Transfer paper 62 suited for this purpose is commonly available and well known in the dye sublimation art. At the conclusion of the printing step, the dye sublimation printer delivers at least one sheet of transfer paper 62 carrying pattern 18. In some cases described below, the software also creates a mirror image of pattern 18 and transmits the mirror image to the printer for printing on another sheet of transfer paper.

Arrow 64 indicates delivery of the transfer paper 62 carrying pattern 18. Paper 62 is carried forward to FIG. 3. Likewise, processing of the clear-coated wind ornament 38 from the conclusion of the steps shown in FIG. 1 has been carried forward to FIG. 3.

In a heat-processing step, a heat press 66 is a means for vaporizing the dye sublimation inks to enable transfer of the inks to the substrate coating on the coated wind ornament. The press provides a press cavity 68 that receives both the wind ornament 38′ and the transfer sheet 62, as suggested by arrows 69 and 70. Upper and lower plates define the press cavity. The plates can be brought together to squeeze or apply surface pressure to the assembled transfer sheet 62 and wind ornament 38′ in the press cavity.

In an assembly step of the transfer sheet 62 and wind ornament 38′, the transfer sheet may be first inserted into the cavity 68 to lie on the lower plate of the press with the printed ink pattern 18′ facing up. Next, the clear-coated wind ornament 38′ is placed on top of the transfer sheet with features of wind ornament registered with features of the pattern 18′. In this instance, registering features of the wind ornament with the pattern refers to aligning the portions of the wind ornament with matching portions of the pattern, so that ink from the transfer sheet is transferred accurately. This process is conducted visually and accommodates reasonable approximation. Small misalignment, such as about one-eighth inch or about three millimeters can be accommodated as will be described, below.

In one alternative for preparing the heat-processing step, a cover sheet 72 is placed in the press cavity 66 on top of the wind ornament 38 and over transfer sheet 62, as suggested by arrow 74. The optional cover sheet 72 is blank paper, applied to shield the deposit of excess ink vapors during use of the press to heat the sublimation inks.

In a second alternative assembly step for preparing the heat-processing step, the cover sheet 72 is a second transfer sheet carrying a pattern 18′ or a mirror image thereof, as may be required to register with the top face of the wind ornament. The additional use of a second transfer sheet 72 enables a surface treatment to be applied to both sides of wind ornament 38′ at the same time. A top transfer sheet 72 carries on its bottom face a printed pattern that is the mirror image of printed pattern 18′, where the mirror image of pattern 18′ is configured to register with the top face of the wind ornament.

The preferred method for preparing to treat both sides of the wind ornament, simultaneously, is to assemble and register the wind ornament 38′ with the top and bottom transfer sheets before inserting the assembly into the press cavity. The wind ornament 38′ is aligned with both top and bottom patterns. After alignment, the top and bottom transfer sheets are fastened together with the wind ornament sandwiched between them, in a fixed position. The assembly is placed in the press cavity 68 as a unit.

The heat press 66 is a suitable means for applying heat and pressure to the wind ornament and to all transfer sheets assembled with it. Typically, a clamping handle 76 controls closure of the heat press 66 by bringing together the upper and lower plates of the press cavity. The amount of pressure applied may be variably selected. The temperature of the press also is adjustable, such as by a thermostat 78. A typical wind ornament 38′ is treated in the clamped press cavity 68 at a temperature of about 400° F over a time of about one minute. At the conclusion of the heat-processing step, the clamp handle 76 is used to open the press. As suggested by arrow 80, the wind ornament is removed from the press. The transfer sheets are discarded. The finished product is a decorated wind ornament 82, having sublimated ink transferred from one or more transfer sheets to the substrate coating of the wind ornament.

The described process enables the creation of a wind ornament 82 that produces unique visual effects. In FIG. 4, the wind ornament 82 is configured to produce the visual effects as the wind ornament twirls on a central vertical axis when suspended from a hanging cord 84 connected to the wind ornament near the top of the vertical axis. This wind ornament is an example of the type of design that best shows the desired visual effect. This wind ornament 82 is formed of metal that is cut to define a central decorative figure surrounded by a series of concentric peripheral geometric figures such as rings. As a nonlimiting example, the geometric figures will be shown and described as being rings of a wind ornament that has a circular periphery. The number of rings is widely variable, with a typical wind ornament having eight or nine rings. As a nonlimiting example, the wind ornament 82 will be described to include only three concentric rings, which will be differentiated according to the relative width as measured on a radius or diameter of the circular wind ornament. The inner ring 86 of smallest dimension will be referred to as the first ring. Center ring 88 of intermediate dimension will be referred to as the second ring. The outer ring 90 of largest dimension will be referred to as the third ring.

The wind ornament 82 also is formed to define a central decorative figure or silhouette 92 that may differ from the geometric shape of the peripheral geometric figures or rings. As a nonlimiting example, the central silhouette 92 is shown and described in the optional configuration of a disk-shaped silhouette. Substantially any other central shape or silhouette is equally suitable, and it may be noted that in FIGS. 1-3 the central figure was represented by a rectangle. More appropriately, the center figure may be chosen to appeal to an intended customer. Thus, popular designs are suitable choices and may be chosen, without limitation, from any animal, plant, celestial object, geographical area, object of nature, man-made object, spiritual symbol, or organizational symbol. The term, silhouette, refers to the fact that the central shape is viewed as two-dimensional. However, the faces of the central shape themselves may be decorated and multicolored to establish a pattern or image, and the central shape may be bent or deformed from a planar configuration to create a more complex or three-dimensional central shape, if desired.

The central shape is separated from the first ring 86 by a gap or slot 94. In turn, a slot 96 separates the first and second rings. A slot 98 separates the second and third rings. The slots are discontinuous at the central vertical axis, where a narrow vertical spine or joining bar 100 crosses each slot, such as both above and below the central silhouette 92. At least one joining bar 100 crosses each slot, whether above the central silhouette, below the central silhouette, or both above and below the central silhouette. The joining bars 100 each provide an area where a peripheral geometric figure can be twisted on the central axis with respect to the central silhouette. Wind ornaments of this design typically are provided from the manufacturer in flat, non-twisted configuration. The customer or end-user typically applies a twist, as he may desire.

The preferred twist may be applied to the first ring by a smallest arc, to the second ring by an intermediate arc, and to the third ring by a largest arc. Each twist may be taken in the same relative direction. Thus, for example, in the view of FIG. 4, the left-hand portions of the rings 86, 88, and 90 would be lifted above the plane of the figure, while the right hand portions of these rings would be lowered below the plane of the figure, or vice versa. As a result each ring is disposed at a small but different acute angle to the plane of the central element 92. As the wind ornament rotates on the cord 84, each ring reflects sunlight to the viewer at a different moment, typically seriatim from first to third ring or from third to first ring. The visual effect is best described as an outward radiating

The density or intensity of coloration produced by the wind ornament 82 provides another aspect of the unique visual effect. FIG. 4 shows stippled patterns applied to the three rings. The density of the stippling on the first ring 86 is greater than the stippling on the second ring 88, which is greater than the stippling on the third ring 90. The differing density of the stippling represents gradation in color or color density or intensity between and among the three rings. The gradation is according to the contour of the concentric rings or other geometric shapes. Thus, for example, a single color such a red can be applied to all rings, with the greatest color density or intensity on the first ring 86, relatively less density or intensity on the second ring 88, and further reduced density or intensity on the third ring 90, or vice versa. Then, as the wind ornament rotates and each ring individually comes into position to reflect sunlight in sequence, the resulting visual effect is remarkably attractive.

Instead of applying a single color to all rings, a variety of colors may be spread from ring to ring. Successive colors of the spectrum are a suitable choice. Thus, the first ring 86 may be red, while the second ring 88 is orange and the third ring 90 is yellow, or vice versa. The rings may carry a gradation of colors. If the inside ring is red and sequentially more outward rings gradually fade to blue, an observer will see a reflection of blue followed by reflections that gradually fade to a red reflection.

As previously disclosed, the metal of the wind ornament is shined, buffed or polished, and no traditional base coat of solid light color is applied. Instead, the shiny metal has been clear-coated, preferably by clear polyester substrate that subsequently receives the sublimated ink. The underlying shiny metal produces unique, enhanced color intensity in the reflected sunlight. The perception of color is accurately described as being a reflection. Dye sublimation inks penetrate the surface of the clear-coat and form a durable colored surface layer that is largely transparent. When struck by sunlight, the colored surface layer reflects back through the clear-coat to the shiny metal backing and then out through the clear-coat to the observer. The observed effect is significantly different than found with a solid color surface such as a paint or a colored varnish.

The central silhouette 92 may be viewed as one or more major color areas. Color applied to the central silhouette may define features of the chosen object as desired. As a nonlimiting example in FIG. 4, the central FIG. 92 is divided into two major color areas, each illustrated as the shape of a spinning drop of liquid, commonly known as yin and yang symbols. As a further extension of the example, each major color area may contain a sub-area, illustrated as a disc 102 that is surrounded by the color of the major area. The boundaries between each major area and sub-area are distinct and exact. Each of the juxtaposed major areas, e.g., the yin and yang symbols, may carry a different selected color that surrounds a disk 102 and that meets the color of the other major area at a cleanly defined border 104, which is sharp and exact. Border 104 indicated by the meeting of the separate colors and preferably not by a scribed borderline. In the example, the colors of the major areas extend to the edge of the adjacent gap or slot 94. A method of coloring the slot sides will be discussed subsequently.

If the central silhouette is other than disc shaped, the gap 94 will border the edge of the central silhouette to define the chosen profile. One or more joining bars 100 are required to interconnect the central silhouette, regardless of its shape, with the first ring. The joining bars may be modified in length or appearance as required according to the shape of the center figure to achieve the interconnection.

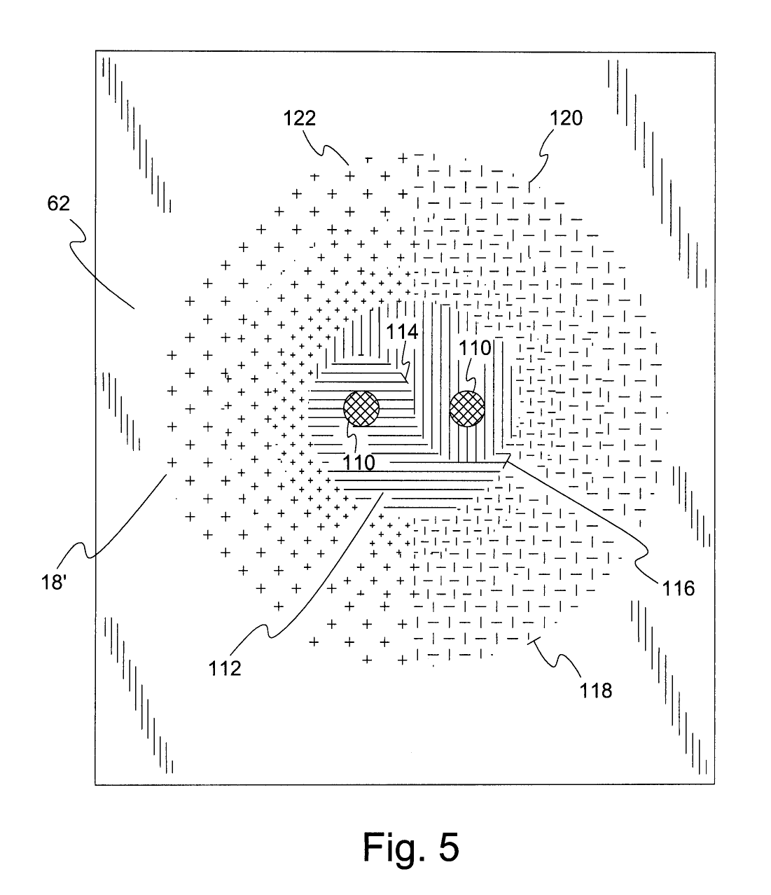

A comparison of FIGS. 4 and 5 shows the preferred coordination of shape between the wind ornament 82 and the ink pattern 18′ that is applied to the transfer sheet 62. Notably, the colored ink applied to sheet 62 only approximately follows the overall unitary shape of the wind ornament. However, the ink pattern 18′ does not closely track borders or cut edges. Instead, the ink pattern extends beyond the inside and outside edges of the rings. For example, the ink extends over the positions of cut slots 94, 96, and 98. Further, the ink is not limited to the outer edge of the wind ornament pattern. Instead the ink of pattern 18′ extends beyond the edge 106 of the wind ornament.

The ink is capable of being applied to transfer sheet 62 in a precise patterns. For example, within the central FIG. 92 the inks sharply define the margins of the sub-areas 102. The ink pattern also sharply defines the meeting 104 between the major color areas. However, at the point registering with cut edge 108 of the central figure, the colors of pattern 18′ may extend outside the edge 108 of the central figure and over at least a part of the gap or slot 94.

FIG. 5 demonstrates this novel deployment of the inks in pattern 18′. The inked sub-areas 110 are sized and positioned to register exactly with color sub-areas 102 of the central figure. Inked area 112 is sized and positioned to register exactly with the major color area of central FIG. 92, with the exception further explained. Inked area 112 includes a clean border between different colors of the major color area, such as border 114 that registers with border 104 of the central figure. The outer edge 116 of the inked area corresponding to the central figure need not cleanly register with outer edge 108 of the central figure. Instead, the outer edge 116 may register with a position beyond edge 108, overlying a portion of gap 94. Similarly, the overall outer edge 118 of the inked pattern 18′ may register with a position beyond outer edge 106 of the wind ornament, itself.

In FIG. 5, the area between positions 116 and 118 would approximately register with the positions of the rings 86, 88, 90 and, hence, may be referred to as the ring area. Notably, the inked pattern 18′ through the ring area is preferred to not specifically show corresponding ring patterns. Instead, the pattern 18′ shows a change in density of the surface pattern from position 116 to position 118. This change in density shows a progression or gradation of color from the first ring 86 to the third ring 90. As previously described in connection with FIG. 4, this change may represent a change in intensity of a single color from ring to ring, a change in identity of color from ring to ring, or a combination of these. The noted changes are not isolated between rings. A single ring may show a gradation or change across its surface.

FIG. 5 shows the additional variation indicated by the use of a surface pattern on the right half 120 of the ring area that differs from the surface pattern on the left half 122 of the ring area. These different surface patterns indicate ink patterns wherein one half of the rings 86, 88, 90 may be differently colored than the other half. Thus, the right half might be colored blue, while the left half is colored red; and each color can be changed in intensity over its half from the first ring to the third. Alternatively, the right half of the rings may be a spectral array of a first selection of colors, and the left half of the rings may be a spectral array of a second selection of colors.

The overall scheme of selected colors may be chosen according to at least two criteria. First, the ring colors should be chosen to create visual impact when struck by bright light, such as sunlight. The underlying shiny metal of the rings 86, 88, 90 provides a stunning effect as it reflects light through the clear coat substrate and the sublimation inks that have entered the substrate. The inks and substrate remain transparent or translucent, such that the underlying shiny metal provides a notable enhancement of appearance. Second, the colors of the center silhouette 92 should be chosen for best display of the figure illustrated in the center silhouette 92. Thus, the yellow of a sun or the red of a strawberry are good choices for those corresponding selections of the item illustrated in the center FIG. 92. The shiny metal of the wind ornament also enhances the colors of the center FIG. 92.

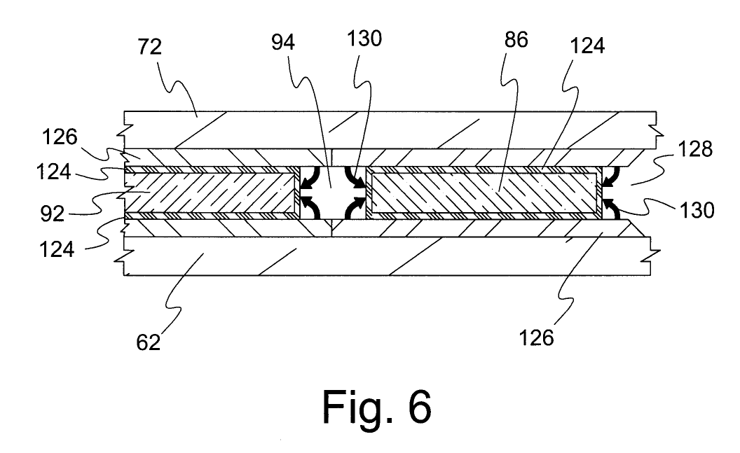

FIG. 6 shows the utility of extending the color areas of pattern 18′ beyond the physical edges of the wind ornament. The detailed view of FIG. 6 shows a portion of an assembly including a central silhouette 92 carrying a clear polyester coating 124. Cutout area 94 separates the central silhouette 92 from the first ring 86. The first ring 86 also carries a clear polyester coating 124. A bottom transfer sheet 62 carries pattern 18′ expressed in dye sublimation ink layer 126. A top transfer sheet 72 carries a reverse image or mirror image of pattern 18′ expressed in a layer 126 of dye sublimation inks. The relative thicknesses of the transfer sheets, ink, wind ornament parts, and clear coat are not to scale, but are shown out of scale for purposes of illustration.

The assembly of FIG. 6 is placed in a heat press 64, FIG. 3, where suitable heat and pressure are applied to sublimate the ink layers 126. In areas where the ink is pressed against substrate 124, the ink accurately transfers to the substrate and becomes incorporated into the substrate, creating a durable and accurately colored coating. Where the ink is exposed to void areas such as slot 94 or end area 128, the ink vapor enters the air or the void. In these void areas, the arrows 130 show the deposit of inks onto the edges of the wind ornament that border the voids. The ink color at each edge extends beyond the contact areas of the ink with the wind ornament. The same color on the juxtaposed face of the wind ornament tends to deposit on the exposed edge, creating color continuity between the faces of the wind ornament and the associated edges of the wind ornament. The areas of color in pattern 18′ extending beyond the edges of the wind ornament also provide a margin for small misalignment between the wind ornament and the ink pattern 18′ on a transfer sheet.

The foregoing is considered as illustrative only of the principles of the invention. Further, since numerous modifications and changes will readily occur to those skilled in the art, it is not desired to limit the invention to the exact construction and operation shown and described, and accordingly all suitable modifications and equivalents may be regarded as falling within the scope of the invention as defined by the claims that follow.

What is claimed is:

1. A method of producing a surface-decorated wind ornament, comprising:
designing a planar physical configuration for a wind ornament to include a series of concentric geometric figures of sequentially decreasing sizes from periphery toward center, with a slot separating juxtaposed geometric figures, and having a spine joining juxtaposed geometric figures across said slot;
forming a wind ornament according to the designed physical configuration from a metal sheet;
coating the formed wind ornament with a substrate suited to receive dye sublimation inks; and
coloring the coated wind ornament with dye sublimation inks.

2. The method according to claim 1, further comprising:
prior to said forming step, selecting a metal sheet and shining said selected metal sheet to form a shiny metal sheet to be used in said forming step.

3. The method according to claim 1, further comprising:
prior to said coating step, shining said formed wind ornament.

4. The method according to claim 1, wherein said coating step comprises:
coating the formed wind ornament with a substrate formed substantially of polyester.

5. The method according to claim 1, wherein said coloring step further comprises:
obtaining a cutout image of the physical configuration design for the wind ornament;
designing a color scheme for the cutout image by grading color across the series of concentric geometric figures;
printing an image of the color scheme on a transfer sheet in dye sublimation inks;
registering the printed image and the coated wind ornament; and
applying heat and pressure to the registered image and ornament sufficient to transfer sublimation inks to the substrate coating.

6. The method according to claim 5, wherein said step of designing a color scheme by grading color further comprises:
grading color between different colors.

7. The method according to claim 5, wherein said step of designing a color scheme by grading color further comprises:
grading color between different densities of one color.

8. The method according to claim 5, wherein said step of designing a color scheme by grading color further comprises:
grading color by contour of each concentric geometric figure.

9. The method according to claim 5, wherein said step of designing a color scheme by grading color further comprises:
grading color continuously across positions of the slots separating juxtaposed geometric figures.

10. Apparatus for producing a surface-decorated wind ornament, comprising:
means for designing a planar physical configuration for a wind ornament to include a series of concentric geometric figures of sequentially decreasing sizes from periphery toward center, with a slot separating juxtaposed geometric figures, and having a spine joining juxtaposed geometric figures across said slot;
means for forming a wind ornament according to the designed physical configuration from a metal sheet;
means for coating the formed wind ornament with a substrate suited to receive dye sublimation inks; and
means for coloring the coated wind ornament with dye sublimation inks.

11. A surface-decorated wind ornament, comprising:
a shiny metal base ornament configured with a series of concentric geometric figures of sequentially decreasing sizes from periphery toward center, with a slot separating juxtaposed geometric figures, and having a spine joining juxtaposed geometric figures across said slot;
a surface coating of clear substrate suited to receive dye sublimation inks; and
a graded surface color scheme of dye sublimation inks carried by said coating.

12. The wind ornament according to claim 11, wherein said clear substrate is formed substantially of polyester.

13. The wind ornament according to claim 11, wherein said graded color scheme further comprises a color gradation between different colors.

14. The wind ornament according to claim 11, wherein said graded color scheme further comprises a color gradation between different densities of one color.

15. The wind ornament according to claim 11, wherein said graded color scheme further comprises a color gradation by contour of each of said concentric geometric figures.
